(19) United States
(12) Patent Application Publication
(10) Pub. No.: US 2017/0209247 A1
(43) Pub. Date: Jul. 27, 2017

(54) Denture Cleaning Brush

(71) Applicants: Sue Hoffman, Bonita Springs, FL (US); Hugh Graham, Bonita Springs, FL (US)

(72) Inventors: Sue Hoffman, Bonita Springs, FL (US); Hugh Graham, Bonita Springs, FL (US)

(21) Appl. No.: 15/165,535

(22) Filed: May 26, 2016

Related U.S. Application Data
(60) Provisional application No. 62/287,079, filed on Jan. 26, 2016.

(51) Int. Cl. A61C 17/00; A46B 9/02; B25G 1/10

(52) U.S. Cl. CPC A61C 17/036; B25G 1/102; A46B 9/025

(57) ABSTRACT

A denture cleaning brush for use in removing food, debris, and bacteria from dentures. The denture cleaning brush includes a handle having a first end with a head thereon and a second end to be held by the user. The handle includes one or more gripping regions thereon that include a high friction or ridged surface to allow the user to more easily hold the handle. The head includes a plurality of tufted bristles extending radially outward therefrom. The bristles are located on the sides and front end of the head and are positioned on a lower portion of the brush head. In this way, the bristles are configured to contact the bottom and sidewalls of the channel of dentures when the denture cleaning brush is positioned therein, allowing the user to easily and fully clean the dentures.

### CROSS REFERENCE TO RELATED APPLICATION

This application claims the benefit of U.S. Provisional Application No. 62/287,079 filed on Jan. 26, 2016. The above identified patent application is herein incorporated by reference in its entirety to provide continuity of disclosure.

### BACKGROUND OF THE INVENTION

Field of the Invention

The present invention relates to denture cleaning devices. More specifically, the present invention provides a denture cleaning brush for use in cleaning dentures or overdentures to remove debris and bacteria thereon.

Many individuals, particularly elderly individuals, wear dentures to allow the user to chew solid food and to provide the user with the appearance of having a full set of teeth. Dentures include a curved body with a set of teeth thereon and further have a channel adapted to receive the user's gums therein. The dentures must be periodically cleaned in order to remove any debris or food particles stuck on the dentures. Further, the dentures must be cleaned in order to remove bacteria that can collect thereon.

In order to clean dentures or overdentures, a toothbrush is often utilized to scrub the interior of the channel of the dentures or overdentures. However, the user must rotate the toothbrush bristles so as to contact all portions of the channel. The toothbrush bristles are not adapted to clean the interior of a channel and the user may have difficulty rotating the toothbrush to clean the interior of the channel. The user is likely to miss spots within the channel and thus may fail to fully clean the channel. The hard brush head of the toothbrush may also damage the dentures if it directly contacts the channel or walls thereof. Thus, cleaning the dentures with a toothbrush is time consuming and inefficient and an improved denture cleaning brush is desired.

Devices have been disclosed in the prior art that relate to cleaning brushes. These include devices that have been patented and published in patent application publications. These devices generally relate to toothbrushes and cleaning brushes, such as U.S. Pat. No. 6,895,629, U.S. Pat. No. 6,119,296, U.S. Design Pat. No. D377,867, U.S. Published Patent Application Number 2013/0276253, and U.S. Pat. No. 1,696,433.

These prior art devices have several known drawbacks. The devices in the prior art relate to toothbrushes and other cleaning brushes having bristles thereon. However, the cleaning brushes are not adapted to cleaning the channel of dentures and do not include a brush having bristles that are configured to clean the entirety of the channel on a set of dentures, the sides of the dentures and the teeth thereon.

In light of the devices disclosed in the prior art, it is submitted that the present invention substantially diverges in design elements from the prior art and consequently it is clear that there is a need in the art for an improvement to existing denture cleaning brush devices. In this regard the instant invention substantially fulfills these needs.

### SUMMARY OF THE INVENTION

In view of the foregoing disadvantages inherent in the known types of denture cleaning devices now present in the prior art, the present invention provides a new denture cleaning brush wherein the same can be utilized for providing convenience for the user when cleaning dentures to remove bacteria and debris thereon.

The present invention provides a denture cleaning brush comprising a handle having a first end having a head thereon and a second end to be held by a user. The handle preferably has an ergonomic configuration and includes one or more gripping regions thereon to improve the user's ability to hold and grasp the handle. The head comprises a plurality of tufted bristles extending radially thereon. The bristles extend from the sides and front end of the head, wherein the bristles are positioned on a lower half of the head, such that the upper portion of the head does not include bristles thereon. In this way, the head is configured to clean the bottom and sidewalls of the channel of dentures such that the user does not have to rotate or adjust the positioning of the brush as he or she cleans the dentures.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the denture cleaning brush.

FIG. 2 shows a side cross sectional view of an embodiment of the denture cleaning brush.

FIG. 3 shows a top down view of the denture cleaning brush.

FIG. 4 shows a cross sectional view of the brush head of the denture cleaning brush.

FIG. 5 shows a perspective view of the denture cleaning device in use to clean dentures.

### DETAILED DESCRIPTION OF THE INVENTION

Reference is made herein to the attached drawings. Like reference numerals are used throughout the drawings to depict like or similar elements of the denture cleaning device. For the purposes of presenting a brief and clear description of the present invention, the preferred embodiment will be discussed as used for cleaning a user's dentures. The figures are intended for representative purposes only and should not be considered to be limiting in any respect.

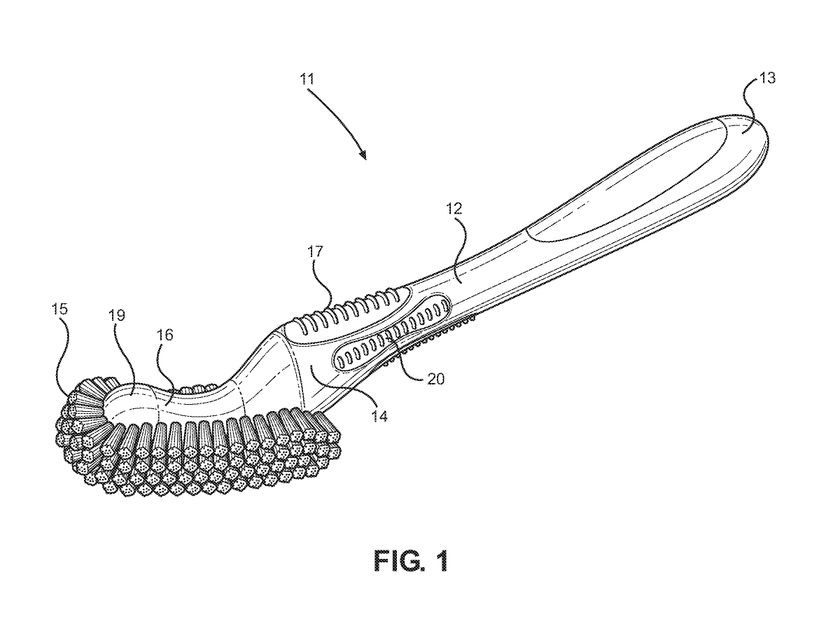

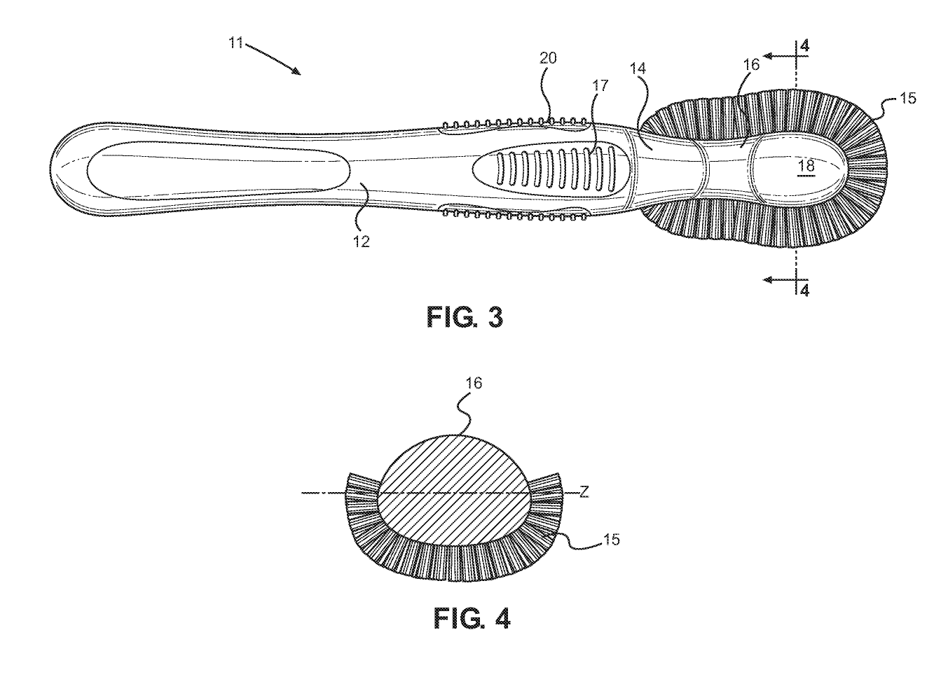

Referring now to FIGS. 1 and 3, there are shown views of the denture cleaning brush. The denture cleaning brush 11 comprises a handle 12 having a first end 13 and a second end 14. The handle 12 preferably has an ergonomic shape so that it can be easily and comfortably held by the user. The second end 14 of the handle 12 is preferably enlarged relative to the first end 13 of the handle 12. The handle 12 is preferably composed of a semi-rigid material that is able to flex to a limited degree.

In some embodiments, the handle 12 further comprises one or more gripping regions 17, 20 thereon. The gripping regions 17, 20 are composed of rubber or other similar high-friction material, or may include ridges thereon for helping the user to more securely hold the handle 12. Preferably, a pair of gripping regions 20 is disposed on opposing sides of the handle 12 at the second end 14 thereof. The gripping regions 20 can be held by the user's thumb and index finger while the user maneuvers the denture cleaning brush 11. Further, a gripping region 17 may be located on an upper surface of the handle 12 and on an underside surface thereof.

The second end 14 of the handle 12 comprises a head 16 having a plurality of bristles 15 on a lower portion thereof. In the illustrated embodiment, the head 16 has an enlarged front end 19. The head 16 is preferably disposed at an angle relative to the handle 12 such that the handle 12 does not contact the channel of the dentures while the user is cleaning the channel using the head 16. Preferably, the angle is other than 180 degrees such that the handle 12 and brush head 16 are not linearly aligned. The handle 12 is configured such that when the head 16 is positioned along a horizontal plane, the handle 12 extends upwardly at an acute angle relative to the horizontal plane.

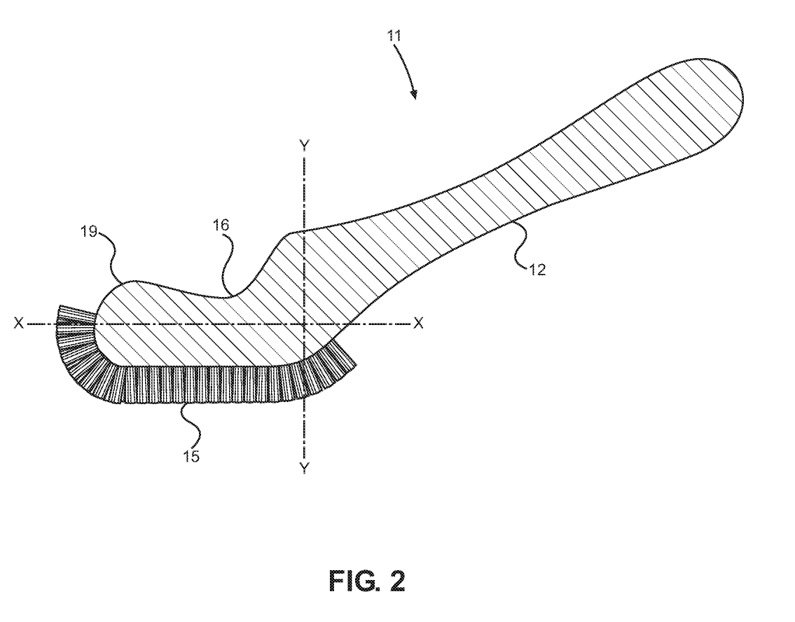

Referring now to FIGS. 2 and 4, there are shown cross sectional views of the brush head of the denture cleaning brush. The head 16 comprises a plurality of bristles 15 extending outward therefrom. The bristles 15 extend along the opposing sides and the front portion 19 of the head 16. Further, the bristles 15 extend from the lower portion of the head 16 such that the upper surface 18 of the head 16 does not include bristles thereon. The bristles 15 extend radially outward from the head 16. Preferably, the bristles 15 are tufted such that the bristles vary in length, allowing the bristles to better clean various portions of the dentures. However, in an alternate embodiment, the bristles 15 are substantially the same size and length.

As shown in FIG. 4, the bristles 15 extend approximately 180 degrees around the head 16 so that the bristles extend between opposing sides of the head 16 along the underside thereof. In a preferred embodiment, the bristles extend roughly 200 degrees around the head 16, such that the bristles 15 on the sides of the head 16 extend upwardly therefrom. This helps to ensure that the bristles 15 contact the sidewalls of the channel of the dentures and that the head 16 does not contact and damage the dentures.

Further, the bristles 15 on the front end 19 of the head 16 extend above a horizontal plane extending through the head 16. The bristles 15 on the front end 19 help to prevent the head 16 from contacting the ends of the channel of the dentures. A rear portion of the head 16 includes bristles 15 extending outwardly therefrom so as to prevent the rear portion of the head 16 from directly contacting the dentures. These bristles 15 also help to provide improved contact of the bristles with the channel of the dentures as the user maneuvers the denture cleaning brush 11.

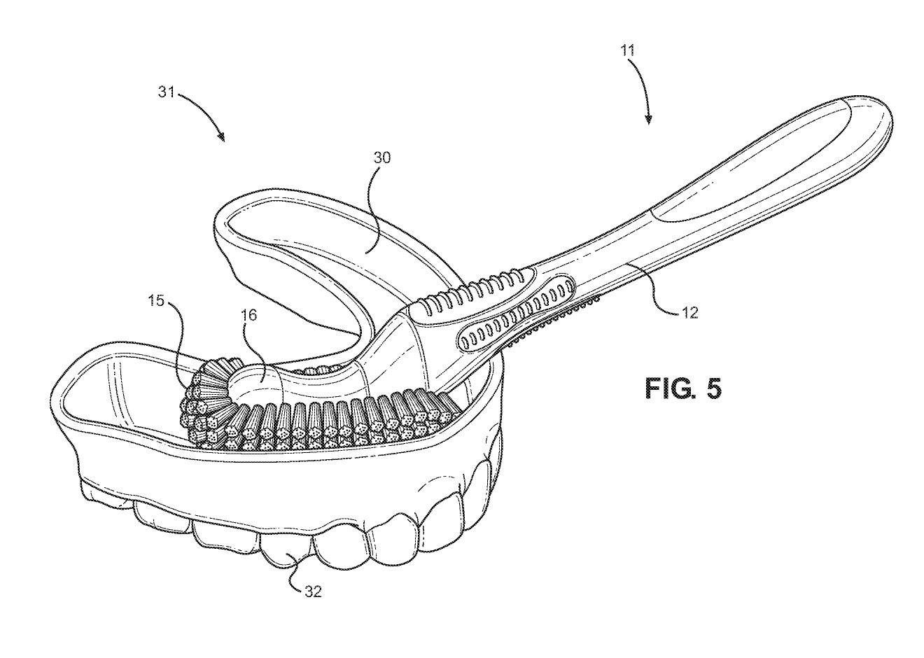

Referring now to FIG. 5, there is shown a perspective view of the denture cleaning device in use to clean dentures. Dentures 31 include a curved body having a channel 30 adapted to receive the user's gums therein. The body further includes teeth 32 disposed thereon so as to resemble and function similarly to natural teeth. In operation, the user can hold the handle 12 of the denture cleaning brush 11, and position the head 16 of the denture cleaning brush 11 within the channel 30 of the dentures 31, wherein the bristles 15 are configured such that they contact the bottom and sides of the channel 30 as the user moves the head 16 of the denture cleaning brush 11 within the channel 30. This allows the user to more easily clean the entirety of the channel 30 without having to rotate and adjust the positioning of the head 16. The bristles 15 can also be rubbed against the teeth 32 and other portions of the dentures 31 in a back and forth motion so as to remove debris or food items stuck therebetween, similar to how a person would conventionally brush their teeth.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A denture cleaning brush, comprising:
a handle having a first end and a second end, wherein the first end includes a head having a bulbous front portion and a pair of opposing sides;
a plurality of bristles that extend from the front portion and the pair of opposing sides of the head, wherein the bristles extend radially outward from the head on a lower portion of the head;
wherein the plurality of bristles form a continuous layer of bristles;
one or more gripping regions disposed at the second end, each of the one or more gripping regions adapted to facilitate grasping the handle;
the one or more gripping regions comprising a first gripping region positioned between a pair of lateral gripping region, the pair of lateral gripping regions disposed on opposing sides thereof;
wherein the head is offset from the handle, the head positioned at an angle relative to the handle forming a recessed area; and
the handle including a tapered section positioned between the first end and the second end, the tapered section having a smaller cross-sectional area than the second end.

2) The denture cleaning brush of claim 1, wherein the handle comprises an ergonomic configuration.

3) (Canceled)

4) (canceled)

5) The denture cleaning brush of claim 1, wherein the plurality of bristles are substantially the same length.

6) The denture cleaning brush of claim 1, wherein the plurality of bristles are tufted.

7) The denture cleaning brush of claim 1, wherein the angle is other than 180 degrees.

8) The denture cleaning brush of claim 1, wherein the front end of the head comprises bristles extending upwardly therefrom.

9) The denture cleaning brush of claim 1, wherein the plurality of bristles extend approximately 180 degrees around the head.
